(19) United States
(12) Patent Application Publication
(10) Pub. No.: US 2004/0065499 A1
(43) Pub. Date: Apr. 8, 2004

(54) Electric-steam propulsion system

(76) Inventor: John Joseph Fasanello JR., Bloomsbury, NJ (US)

Correspondence Address: John Fasanello, Jr., P.O. Box 335, Bloomsbury, NJ, 08804-0335, US

(21) Appl. No.: 10/410,460

(22) Filed: Apr. 9, 2003

Related U.S. Application Data
(60) Provisional application No. 60/389,414, filed on Jun. 17, 2002.

(51) Int. Cl. B60K 3/00

(52) U.S. Cl. 180/303

(57) ABSTRACT

An improved method of propelling land, water, and air vehicles by utilizing an electrical source of initial energy (10), a “flash”-type boiler (14), and a steam engine (16). The system employs the usual devices, such as an alternator (22), voltage regulator (24), and other appurtenances of modern vehicles.

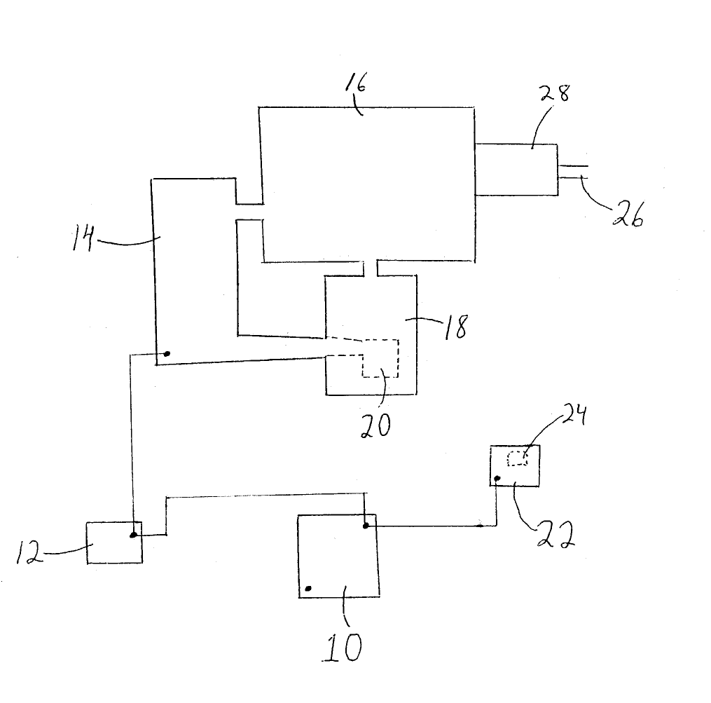

### BACKGROUND

1. Field of Invention

This invention relates to methods of propelling vehicles on land and water and in the air without using wood, fossil fuels, or any other combustible material.

This invention claims the benefit of Provisional Patent Application Ser. No. 60/389,414, filed 2002 June 17.

2. Description of Prior Art

Conveyances such as autos, trucks, buses, trains, airplanes, boats, and the like have been powered by engines of various types. Most prominent in that regard have been fossil-fuel-powered engines. Even steam-engined vehicles like the Stanley Steamer and trains, however, have utilized fossil fuels to create steam by boiling water, thus polluting the atmosphere, as well as the soil and vegetation, and the ground water.

Modern attempts to build steam-powered cars still depend on the burning of petroleum-based fuel to create the heat to boil the water to produce the steam. Those vehicles, then, still cause pollution, and still require petroleum-based products, which may not be so easy to procure in the future or during wars.

Another problem with fuel-burning engines is that they must be manufactured with all sorts of pollution-controlling devices, thus increasing both costs and the chances for breakdowns because of complexity of construction.

Because of ever-increasing laws regarding how many and to what extent contaminants may be spewed into the atmosphere, not only do costs increase, but many motorists become irate when they are denied the use of vehicles exceeding the pollution limits enacted into law.

Even the simple use of exhaust pipes and mufflers, in addition to cost and frequency of replacement, has become complicated by the anti-pollution laws of states and nations.

Aside from fossil-fueled engines, other methods of propulsion have been tried but found wanting. For example, solar energy, while non-polluting, does not provide enough power for a long enough duration to be practical.

Battery-powered vehicles must be extremely heavy because of the number of batteries required to move a vehicle for a reasonable distance and for a fairly long duration. They also need constant recharging. Therefore, costs are prohibitive, especially in terms of value per dollar expended to travel any goodly distance.

The combination of gasoline and electricity used to power some recently-produced autos is promising in terms of miles-per-gallon, but still produces pollution and requires many parts for both operation and cleansing of exhaust gases, as well as constant purchases of fuel.

Hydrogen fuel cells produce no pollution but would add large amounts of water vapor to the air, thus increasing humidity to such an extent as, perhaps, to worsen other problems, including breathing for certain sufferers. Besides there is no easy source of hydrogen, and to produce the gas would still require vast amounts of electricity, which would be obtained by burning large amounts of fossil fuels or by atomic means.

Propane burns cleaner than gasoline but is a product of refining and does not exist in nature; it would still cause pollution by burning. So would natural gas or methane; none of these methods is pollution-free. Some are also dangerous because of high volatility.

Other devices, such as large flywheels or coiled springs, are highly impractical for powering vehicles.

### OBJECTS AND ADVANTAGES

The present invention, the electric-steam propulsion system, has several objects and advantages:

(a) to provide a source of power for vehicles that will greatly reduce atmospheric, soil, and water pollution;

(b) to reduce costs of purchase, operation, and repairs by eliminating many parts needed in other engines, such as sparkplugs, coils, fuel injectors, exhaust systems, catalytic converters, special anti-pollution devices and so on;

(c) to reduce costs and save natural resources by obviating the need to purchase combustibles such as gasoline every time a previously purchased supply has been consumed;

(d) to aid the cause of good health by greatly reducing contaminants in soil, water, and air;

(e) to eliminate the dangers of asphyxiation by reason of noxious exhaust gases;

(f) to reduce the dangers of the “greenhouse effect,” if such really is a problem caused partly by engine exhaust gases;

(g) to reduce the possibility of fire or explosion caused by mishaps involving combustible fuels;

(h) to shorten time traveled by eliminating the need to stop for refueling;

(i) to reduce the weight and cost of vehicles by using fewer parts associated with typical engines, exhaust systems, and drive trains;

j) to reduce the odors and heat associated with fuel-burning engines.

Further objects and advantages of my invention will become apparent from a consideration of the ensuing description.

Drawing

The single attached drawing is simple and straightforward. Because the new invention is based on and utilizes existing devices for its operation, anyone with a modicum of mechanical knowledge can understand the system.

The parts of my invention include a battery or batteries, an inverter, a “flash” boiler, a steam engine, an alternator, a voltage regulator, a condenser, a pump, a device, such as a drive shaft, of propulsion-power transference for a vehicle; and a transmission, if required, depending on the type of steam engine utilized.

### REFERENCE NUMERALS IN DRAWING

| | |
|---|---|
| 10 battery | 12 inverter |
| 14 flash boiler | 16 steam engine |
| 18 condenser | 20 pump |
| 22 alternator | 24 voltage regulator |
| 26 propulsion-power | 28 optional transmission |
| transference device | |

Summary

In accordance with the present invention, land, water, and airborne vehicles are propelled by a new combination of electrical and steam devices.

Description

A typical embodiment of the propulsion system is illustrated in the drawing. Included are a battery or batteries 10. Also utilized are an inverter 12 and a steam boiler of a rapid-heating nature, such as a “flash” boiler 14, and a steam engine 16. A condenser 18 and a pump 20 are included in the system.

An alternator 22 and a voltage regulator 24 are parts of the main electrical system. A method of propulsive-power transference such as a drive shaft 26 and an optional transmission 28 complete the basic system.

All other usual parts, such as belts, fuses, accessories and the like need not obtrude into the depiction of the new uses of the main elements of the invention, as they are ancillary.

The reader, therefore, will see that my electric-steam propulsion system provides a simple, reliable, economic, non-polluting method of powering conveyances on land and water, and in the air; and greatly reduces dependence on fossil fuels, thus aiding the quality of plant and animal life on earth and saving natural resources.

In addition, due to less pollution, good health shall be fostered in general, and the use of vehicle exhaust for suicide, eliminated. Fires and explosions due to crashes will also be done away with. Exhaust gases will be reduced to such a level that they will not increase the alleged “greenhouse effect.” The foul odors of burning fuels will also largely disappear. In short, the whole system of combustion engines, with all their complexity, costs, and various types of pollution and other problems will be greatly minimized, if not entirely ended.

Operation

The electric-steam propulsion system employs parts typically found in vehicles for land, water, and atmospheric travel and similar uses. It differs basically in that electricity, not fossil fuels, sunlight, or even simply batteries, is used to provide the basic source of power to create steam and drive an engine.

A battery or batteries of sufficient strength 10 provide electricity to an inverter 12 to rapidly heat fluid in an efficient boiler such as the “flash” variety 14, which very quickly brings up steam. The entire fluid-steam flow occurs in a tightly-sealed system.

The resultant steam is then utilized to drive a steam engine 16, which will transfer power by methods such as a drive shaft or other typical devices to an actual vehicle-propelling device, whether wheels, propellers, or other device.

Steam will become liquid once again by means of a condenser, such as a radiator 18 and returned to the boiler by the action of a pump 20, unless a gravity-feed or other operation can be employed. Then the process will be repeated as new steam is made. Since the system is sealed as tightly as possible, there will be no or little loss of fluid or steam. Since this type of engine can run with very little fluid needed, hardly any pollution will occur. In addition, there is no danger of explosion with this kind of steam engine, thus giving a great safety factor over other types of steam engines and fossil-fuel engines.

In order to recharge and operate the electrical system, a typical alternator 22 is employed, along with a typical voltage regulator 24, just as currently found in typical conveyances. A transmission 28 for conducting motive power from the engine through a propulsion-transference device, such as a drive shaft 26, is optional, depending on the type of steam engine used in the system. For example, a two-cylinder, double-acting full Uniflow engine requires no gearbox.

Other types of engines may need a gearbox to get power to the actual vehicle-moving device.

This description of the basic operation of the invention omits all the other aspects of modern vehicles, as they are not involved in the elemental system. Belts and accessories, for example, will be provided by vehicle manufacturers in typical manners.

Also not covered in detail is a major embodiment whereby my invention is used in a stationary setting to produce electricity by utilizing an electricity-generating device in place of a transmission or other propulsion device.

### CONCLUSION, RAMIFICATIONS, AND SCOPE

Accordingly, the electric-steam propulsion system has distinct advantages over other methods of self-propelling vehicles. For one, it greatly reduces pollution of the environment. Further, it has additional advantages in that

it reduces costs of manufacture, operation, and repairs by virtue of requiring fewer parts;

it saves natural resources by drastically curtailing the demand for gasoline;

it reduces the results of the “greenhouse effect”;

it aids the cause of good health and “quality of life”;

it greatly reduces the possibility of fires and explosions associated with gasoline engines;

it prevents asphyxiation by exhaust gases;

it reduces noxious odors and heat from burning gasoline;

it reduces travel times and costs because of the ability to progress for long periods of time without needing to refuel.

Although my above description contains many specificities, these should not be construed as limitations on the scope of the invention, but rather as the exemplification of one major embodiment thereof. Many other variations are possible. For example, one important variation is to use the basic device to generate electricity by substituting a generator for the transmission. Thus, individuals, villages, and other entities could produce electricity for themselves.

In addition, large power-generating plants, using much larger batteries and other components, could generate electricity for distribution and sale while eliminating reliance on either fossil fuels or atomic energy; thus, fewer pollutants would occur, and the dangers of atomic contamination or worse would be eliminated entirely.

A different type of boiler may be employed in such stationary applications that may not require a “flash” boiler.

Therefore, the scope of the invention should be determined by the appended claims and their legal equivalents, rather than by the examples given.

I claim:

1. In a self-propelled vehicle, an electric-steam system method of propulsion, the improvement comprising:
a. a means of electrical power, such as a battery, for providing initial energy in said system
b. means, such as an electrical inverter, for converting direct current electricity into alternating current electricity
c. means selected from the group consisting of “flash”-type boilers for rapidly boiling liquid
d. an engine for utilizing steam to provide mechanical energy
e. means, such as a drive shaft, for controllably coupling said mechanical energy from said engine to a device or devices whereby said vehicle will be self-propelled
f. means, such as a radiator, for condensing said steam back into said liquid
g. means, such as a pump, for returning said liquid to said boiler
h. means, such as a voltage regulator, for controlling the amount and flow of said electricity in said system
i. means, such as an alternator, for continuing to provide electricity for recharging said initial source of energy and operating accessories, whereby said system will operate as long as is desired.

2. The system of claim 1 utilized in a stationary configuration, further including and substituting for said means in 1.e for controllably coupling said mechanical energy produced by a steam engine for propelling a vehicle, a means selected from the group consisting of generators for producing electricity, whereby said electricity may be utilized in a multitude of ways.
